(19) United States
(12) Patent Application Publication
(10) Pub. No.: US 2011/0206883 A1
(43) Pub. Date: Aug. 25, 2011

(54) POLYMERIZATION WITH ENHANCED GLYCOL ETHER FORMULATION

(75) Inventors: Noel M. Hasty, Wilmington, DE (US); Edward J. Stancik, Wilmington, DE (US)

(73) Assignee: E.I. DUPONT DE NEMOURS AND COMPANY, Wilmington, DE (US)

(21) Appl. No.: 13/127,067

(22) PCT Filed: Dec. 14, 2009
(86) PCT No.: PCT/US09/67863

§ 371 Date: May 2, 2011

Related U.S. Application Data
(60) Provisional application No. 61/122,500, filed on Dec. 15, 2008.

(51) Int. Cl. C08G 63/672; C08G 63/688; C08L 67/02; C08L 3/00; C08G 63/85; B32B 1/02

(52) U.S. Cl. 428/36.92; 528/301; 528/302; 528/293; 528/295; 525/448; 524/47; 528/279

(57) ABSTRACT

The polymerization processes described herein provide methods for dehydrating diols such that dimers of the diols are formed and incorporated into polyesters during polycondensation. Control over this phenomenon provides unique polymer compositions with a range of thermo-mechanical properties, crystallinity, bio-content and biodegradability. Generation of a wide range of properties allows development of polymers that can be used for a wide range of applications.

### FIELD OF THE INVENTION

The polymerization processes described herein provide methods for dehydrating diols such that dimers of the diols are formed and incorporated into polyesters during polycondensation. Control over this phenomenon provides unique polymer compositions with a range of thermo-mechanical properties, crystallinity, bio-content and biodegradability. Generation of a wide range of properties allows development of polymers that can be used for a wide range of applications.

### BACKGROUND

For numerous reasons, there is growing resistance to the use of petroleum as either a fuel or material feedstock. Instead, there is a trend towards increasing sustainability and reducing carbon footprint. Similarly, consideration of end of life scenario is gaining importance in product design. In the polymer world, these trends have manifested themselves in a search for monomers that are derived from a biological source and that impart biodegradability on the polymers into which they are incorporated.

An opposing force is cost. Generally, the cost of planting and harvesting a natural crop, extracting the essential oils, converting these oils into monomers, and carrying out interspersed purification steps is higher than relying on the massive infrastructure established around the petroleum industry to produce a given monomer. Even when the natural source for a given monomer is preferred over the petroleum source, there are often alternate monomers from the petroleum source that can provide the desired properties at a lower cost or higher stability.

A hurdle is presented when one looks for alternate monomers from a biological source that can provide the desired properties at lower cost or higher stability. An example of a monomer that illustrates these points is sebacic acid. It is desirable from a sustainability viewpoint in that it is derived from a natural source, the castor plant, and can provide aliphatic ester linkages, which improve the biodegradability of polyesters. On the other hand, a number of factors can create instability in its price. For one, the vast majority of castor oil is produced in a single country. Similarly, the vast majority of castor oil is converted to sebacic acid in a second single country. Therefore, both the supply of castor oil and its conversion to sebacic acid can be negatively impacted by geopolitical or natural events in a localized region of the world.

An advantage is offered by the ability to adjust raw materials feed rates and still produce copolymers with consistent thermal properties. Control over the dimerization of the constituent glycols provides a means to achieve this. If costs of one monomer increase significantly, the rate of dimerization can be adjusted appropriately to reduce the use of that monomer. If customers desire a range of other physical properties from a set of copolymers with the same thermal properties, then they can be produced from the same monomers by simultaneously adjusting monomer feeds and glycol dimerization rate.

Aliphatic-aromatic polyetheresters described in the art generally include polyesters derived from a mixture of aliphatic dicarboxylic acids and aromatic dicarboxylic acids, which also incorporate poly(alkylene ether)glycols. Generally, known aliphatic-aromatic copolyetheresters incorporate high levels of the poly(alkylene ether)glycol component. For example, Warzelhan, et al. disclose aliphatic-aromatic polyetherester compositions in U.S. Pat. Nos. 5,936,045, 6,046,248, 6,258,924, and 6,297,347 that have 20-25 mole percent of the poly(alkylene ether)glycol component and are found to have lowered crystalline melting point temperatures in the range of 111° C. to 127.5° C.

More recently, Hayes in U.S. Pat. No. 7,144,632, discloses aliphatic-aromatic polyetherester compositions that include 0.1 to about 3 mole percent of a poly(alkylene ether)glycol component with enhanced thermal properties. The poly(alkylene ether)glycol is added as a separate monomer in each of the cases above. Also, the poly(alkylene ether)glycol is composed primarily of greater than 2 linked monomer units and of a range of molecular weights.

The present invention provides polymerization processes described herein provide methods for dehydrating diols such that dimers of the diols are formed and incorporated into polyesters during polycondensation. Control over this phenomenon provides unique polymer compositions with a range of thermo-mechanical properties, crystallinity, bio-content and biodegradability.

### SUMMARY OF THE INVENTION

The present invention relates to an aliphatic-aromatic copolyetherester comprising an acid component and a glycol component; wherein the acid component comprises:
a. about 90 to 10 mole percent of an aromatic dicarboxylic acid component based on 100 mole percent total acid component; and
b. about 10 to 90 mole percent of an aliphatic dicarboxylic acid component based on 100 mole percent of total acid component; and

wherein the glycol component consists essentially of:
a. about 99.8 to 0.2 mole percent of a single glycol component based on 100 mole percent total glycol component; and
b. about 0.2 to 99.8 mole percent of a dialkylene glycol component based on 100 mole percent total glycol component.

It further relates to the aliphatic-aromatic copolyetherester, obtainable by reacting an acid component mixture comprising:
a. about 90 to 10 mole percent of an aromatic dicarboxylic acid or ester-forming derivative thereof based on 100 mole percent total acid component, and
b. about 10 to 90 mole percent of an aliphatic dicarboxylic acid or ester-forming derivative thereof based on 100 mole percent of total acid component,

and a glycol component consisting essentially of:
c. 100 mole percent of a single glycol component based on 100 mole percent total glycol component.

The invention further relates to a process to make aliphatic-aromatic copolyetheresters, comprising:
a. combining one or more dicarboxylic acid monomers or diester derivatives thereof with a diol in the presence of an ester interchange catalyst to form a first reaction mixture of an ester interchange reaction;
b. heating the first reaction mixture with mixing to a temperature between about 200 degrees C. and about 260 degrees C., whereby volatile products of the ester interchange reaction are distilled off, to form a second reaction mixture; and
c. polycondensing the second reaction mixture with stirring at a temperature between about 240 degrees C. and 260 degrees C. under vacuum to form an aliphatic-aromatic copolyetherester.

The invention further relates to blends of aliphatic-aromatic copolyetheresters with other materials, including natural substances. It also relates to shaped articles comprising aliphatic-aromatic copolyetheresters.

### DETAILS

Described herein are copolyetheresters and methods to achieve various properties normally imparted by aliphatic dicarboxylic acids on aliphatic-aromatic polyesters by inclusion of dimers of some fraction of the constituent glycols. The copolyetheresters may be amorphous or semicrystalline. The term “semicrystalline” is intended to indicate that some fraction of the polymer chains of the aromatic-aliphatic copolyesters reside in a crystalline phase with the remaining fraction of the polymer chains residing in a non-ordered glassy amorphous phase. The crystalline phase is characterized by a melting temperature, Tm, and the amorphous phase by a glass transition temperature, Tg, which can be measured using Differential Scanning calorimetry (DSC). Note that the esters, anhydrides, or ester-forming derivatives of the acids may be used. The terms “glycol” and “diol” are used interchangeably to refer to general compositions of a primary, secondary, or tertiary alcohol containing two hydroxyl groups. Furthermore, methods to produce, and to control the degree of production of these dimer glycols during the polymerization process, are described. By these methods, a dimer glycol need not necessarily be charged to the reaction vessel but can instead be formed in situ from a charged glycol monomer. This provides both a simplification and a cost savings to the process.

An illustration of the advantage provided by this approach is seen with regard to sebacic acid. Reaction of this monomer with terephthalic acid and 1,3-propanediol generates copolyesters that are useful for a number of applications. By a traditional approach, if one desired a certain set of thermal properties, the ratio of terephthalic acid and sebacic acid would be set to a specific value. Also in a traditional approach, using only these 3 monomers, no degree of freedom exists for the raw materials feed ratio if a specific set of thermal properties must be met. In contrast, by the approach described herein these thermal properties are achieved with a variety of raw materials feed ratios. In the limit of restricting dimerization of the 1,3-propanediol to 0, the feed rates would be the same as those for the traditional approach. When a small degree of dimerization is encouraged, then the 1,3-propanediol feed rate is increased slightly while the sebacic acid feed rate is decreased slightly. If a large degree of dimerization is encouraged, then the 1,3-propanediol feed rate is increased significantly while the sebacic acid feed rate is decreased significantly. In each case, with appropriate control, the copolymer has the desired target thermal properties. In this specific example, the content of one monomer, sebacic acid, from a biological source is balanced against another, 1,3-propanediol, that is also from a biological source.

The polymerization processes described herein provide methods for dehydrating diols such that dimers of the diols are formed and incorporated into polyesters during polycondensation. Control over this phenomenon provides unique polymer compositions with a range of thermo-mechanical properties, crystallinity, bio-content and biodegradability. Generation of a wide range of properties allows development of polymers that can be used for a wide range of applications. Control over dimerization and the resulting impact on polymer composition and properties are illustrated by the examples below.

Disclosed herein are aliphatic-aromatic copolyetheresters, which comprise an acid component and a glycol component. Generally the acid component will comprise between about 90 and 10 mole percent of an aromatic dicarboxylic acid component based on 100 mole percent total acid component, and between about 10 and 90 mole percent of an aliphatic dicarboxylic acid component based on 100 mole percent of total acid component. Additionally, the glycol component consists essentially of about 99.8 to 0.2 mole percent of a single glycol component based on 100 mole percent total glycol component, and about 0.2 to 99.8 mole percent of a dialkylene glycol component based on 100 mole percent total glycol component.

Typically, the acid component will comprise greater than about 20 mole percent of an aliphatic dicarboxylic acid component based on 100 mole percent of total acid component. In some embodiments, the acid component will comprise greater than about 40 mole percent of an aliphatic dicarboxylic acid component based on 100 mole percent total acid component.

Generally, the glycol component consists essentially of less than 99.8 mole percent of a single glycol component and greater than 0.2 mole percent of a dialkylene glycol component based on 100 mole percent total glycol component. Typically, the glycol component consists essentially of less than 99 mole percent of a single glycol component and greater than 1 mole percent of a dialkylene glycol component based on 100 mole percent total glycol component. More typically, the glycol component consists essentially of less than 98 mole percent of a single glycol component and greater than 2 mole percent of a dialkylene glycol component based on 100 mole percent total glycol component. In some embodiments, the glycol component consists essentially of less than 95 mole percent of a single glycol component and greater than 5 mole percent of a dialkylene glycol component based on 100 mole percent total glycol component. In still other embodiments, the glycol component consists essentially of less than 90 mole percent of a single glycol component and greater than 10 mole percent of a dialkylene glycol component based on 100 mole percent total glycol component.

Generally, the glycol component consists essentially of greater than 12.8 mole percent of a single glycol component and less than 87.2 mole percent of a dialkylene glycol component based on 100 mole percent total glycol component. Typically, the glycol component consists essentially of greater than 40 mole percent of a single glycol component and less than 60 mole percent of a dialkylene glycol component based on 100 mole percent total glycol component. More typically, the glycol component consists essentially of greater than 60 mole percent of a single glycol component and less than 40 mole percent of a dialkylene glycol component based on 100 mole percent total glycol component.

Aromatic dicarboxylic acid components useful in the aliphatic-aromatic copolyetheresters include unsubstituted and substituted aromatic dicarboxylic acids, bis(glycolates) of aromatic dicarboxylic acids, and lower alkyl esters of aromatic dicarboxylic acids having from 8 carbons to 20 carbons. Examples of desirable dicarboxylic acid components include those derived from terephthalates, isophthalates, naphthalates and bibenzoates. Specific examples of desirable aromatic dicarboxylic acid component include terephthalic acid, dimethyl terephthalate, bis(2-hydroxyethyl)terephthalate, bis(3-hydroxypropyl)terephthalate, bis(4-hydroxybutyl)terephthalate, isophthalic acid, dimethyl isophthalate, bis(2-hydroxyethyl)isophthalate, bis(3-hydroxypropyl)isophthalate, bis(4-hydroxybutyl)isophthalate, 2,6-napthalene dicarboxylic acid, dimethyl 2,6-naphthalate, 2,7-naphthalenedicarboxylic acid, dimethyl 2,7-naphthalate, 3,4′-diphenyl ether dicarboxylic acid, dimethyl 3,4′-diphenyl ether dicarboxylate, 4,4′-diphenyl ether dicarboxylic acid, dimethyl 4,4′-diphenyl ether dicarboxylate, 3,4′-diphenyl sulfide dicarboxylic acid, dimethyl 3,4′-diphenyl sulfide dicarboxylate, 4,4′-diphenyl sulfide dicarboxylic acid, dimethyl 4,4′-diphenyl sulfide dicarboxylate, 3,4′-diphenyl sulfone dicarboxylic acid, dimethyl 3,4′-diphenyl sulfone dicarboxylate, 4,4′-diphenyl sulfone dicarboxylic acid, dimethyl 4,4′-diphenyl sulfone dicarboxylate, 3,4′-benzophenonedicarboxylic acid, dimethyl 3,4′-benzophenonedicarboxylate, 4,4′-benzophenonedicarboxylic acid, dimethyl 4,4′-benzophenonedicarboxylate, 1,4-naphthalenedicarboxylic acid, dimethyl 1,4-naphthalate, 4,4′-methylenebis(benzoic acid), dimethyl 4,4′-methylenebis(benzoate), and mixtures derived therefrom. Preferably, the aromatic dicarboxylic acid component is derived from terephthalic acid, dimethyl terephthalate, bis(2-hydroxyethyl)terephthalate, bis(3-hydroxypropyl)terephthalate, bis(4-hydroxybutyl)terephthalate, isophthalic acid, dimethyl isophthalate, bis(2-hydroxyethyl)isophthalate, bis(3-hydroxypropyl)isophthalate, bis(4-hydroxybutyl)isophthalate, 2,6-naphthalenedicarboxylic acid, dimethyl 2,6-naphthalate, and mixtures derived therefrom. However, essentially any aromatic dicarboxylic acid known can be used. Aliphatic dicarboxylic acid components useful in the aliphatic-aromatic copolyetheresters include unsubstituted, substituted, linear, and branched, aliphatic dicarboxylic acids, bisglycolates of aliphatic dicarboxylic acids, and lower alkyl esters of aliphatic dicarboxylic acids having 2 to 36 carbon atoms. Specific examples of desirable aliphatic dicarboxylic acid components include, oxalic acid, dimethyl oxalate, malonic acid, dimethyl malonate, succinic acid, dimethyl succinate, methylsuccinic acid, glutaric acid, dimethyl glutarate, bis(2-hydroxyethyl)glutarate, bis(3-hydroxypropyl)glutarate, bis(4-hydroxybutyl)glutarate, 2-methylglutaric acid, 3-methylglutaric acid, adipic acid, dimethyl adipate, bis(2-hydroxyethyl)adipate, bis(3-hydroxypropyl)adipate, bis(4-hydroxybutyl)adipate, 3-methyladipic acid, 2,2,5,5-tetramethylhexanedioic acid, pimelic acid, suberic acid, azelaic acid, dimethyl azelate, sebacic acid, dimethyl sebacate, 1,11-undecanedicarboxylic acid (brassylic acid), 1,10-decanedicarboxylic acid, undecanedioic acid, 1,12-dodecanedicarboxylic acid, hexadecanedioic acid, docosanedioic acid, tetracosanedioic acid, dimer acid, and mixtures derived therefrom. Preferably, the linear aliphatic dicarboxylic acid component is derived from a renewable biological source, in particular succinic acid, azelaic acid, sebacic acid, and brassylic acid. However, essentially any aliphatic dicarboxylic acid known can be used.

The single glycols that typically find use in the embodiments disclosed herein include alkanediols with 2 to 10 carbon atoms and cycloalkanediols with 5 to 10 carbon atoms. Examples include 1,2-ethanediol, 1,3-propanediol, 1,4-butanediol, and trans-1,4-cyclohexanedimethanol (CHDM). However, essentially any glycol known can be used including those containing aromatic or heterogeneous structures. Of these, 1,3-propanediol is more often used, and because it can be bio-derived (renewably sourced) is advantageous for the reasons disclosed herein.

The 1,3-propanediol used in the embodiments disclosed herein is preferably obtained biochemically from a renewable source (“biologically-derived” 1,3-propanediol).

A particularly preferred source of 1,3-propanediol is via a fermentation process using a renewable biological source. As an illustrative example of a starting material from a renewable source, biochemical routes to 1,3-propanediol (PDO) have been described that utilize feedstocks produced from biological and renewable resources such as corn feed stock. For example, bacterial strains able to convert glycerol into 1,3-propanediol are found in the species Klebsiella, Citrobacter, Clostridium, and Lactobacillus. The technique is disclosed in several publications, including U.S. Pat. No. 5,633,362, U.S. Pat. No. 5,686,276 and U.S. Pat. No. 5,821,092. U.S. Pat. No. 5,821,092 discloses, inter alia, a process for the biological production of 1,3-propanediol from glycerol using recombinant organisms. The process incorporates E. coli bacteria, transformed with a heterologous pdu diol dehydratase gene, having specificity for 1,2-propanediol. The transformed E. coli is grown in the presence of glycerol as a carbon source and 1,3-propanediol is isolated from the growth media. Since both bacteria and yeasts can convert glucose (e.g., corn sugar) or other carbohydrates to glycerol, the processes disclosed in these publications provide a rapid, inexpensive and environmentally responsible source of 1,3-propanediol monomer.

The biologically-derived 1,3-propanediol, such as produced by the processes described and referenced above, contains carbon from the atmospheric carbon dioxide incorporated by plants, which compose the feedstock for the production of the 1,3-propanediol. In this way, the biologically-derived 1,3-propanediol preferred for use in the context of the present invention contains only renewable carbon, and not fossil fuel-based or petroleum-based carbon. The polytrimethylene terephthalate based thereon utilizing the biologically-derived 1,3-propanediol, therefore, has less impact on the environment as the 1,3-propanediol used does not deplete diminishing fossil fuels and, upon degradation, releases carbon back to the atmosphere for use by plants once again. Thus, the compositions of the present invention can be characterized as more natural and having less environmental impact than similar compositions comprising petroleum based diols.

The biologically-derived 1,3-propanediol, and polytrimethylene terephthalate based thereon, may be distinguished from similar compounds produced from a petrochemical source or from fossil fuel carbon by dual carbon-isotopic finger printing. This method usefully distinguishes chemically-identical materials, and apportions carbon material by source (and possibly year) of growth of the biospheric (plant) component. The isotopes, ¹⁴C and ¹³C, bring complementary information to this problem. The radiocarbon dating isotope (¹⁴C), with its nuclear half life of 5730 years, clearly allows one to apportion specimen carbon between fossil (“dead”) and biospheric (“alive”) feedstocks (Currie, L. A. “Source Apportionment of Atmospheric Particles,” Characterization of Environmental Particles, J. Buffle and H. P. van Leeuwen, Eds., 1 of Vol. I of the IUPAC Environmental Analytical Chemistry Series (Lewis Publishers, Inc) (1992) 3-74). The basic assumption in radiocarbon dating is that the constancy of ¹⁴C concentration in the atmosphere leads to the constancy of ¹⁴C in living organisms. When dealing with an isolated sample, the age of a sample can be deduced approximately by the relationship:

t=(−5730/0.693)ln(A/A₀)

wherein t=age, 5730 years is the half-life of radiocarbon, and A and A₀ are the specific ¹⁴C activity of the sample and of the modern standard, respectively (Hsieh, Y., Soil Sci. Soc. Am J., 56, 460, (1992)). However, because of atmospheric nuclear testing since 1950 and the burning of fossil fuel since 1850, ¹⁴C has acquired a second, geochemical time characteristic. Its concentration in atmospheric CO₂, and hence in the living biosphere, approximately doubled at the peak of nuclear testing, in the mid-1960s. It has since been gradually returning to the steady-state cosmogenic (atmospheric) baseline isotope ratio (¹⁴C/¹²C) of ca. 1.2×10⁻¹², with an approximate relaxation “half-life” of 7-10 years. This latter half-life must not be taken literally; rather, one must use the detailed atmospheric nuclear input/decay function to trace the variation of atmospheric and biospheric ¹⁴C since the onset of the nuclear age. It is this latter biospheric ¹⁴C time characteristic that holds out the promise of annual dating of recent biospheric carbon. ¹⁴C can be measured by accelerator mass spectrometry (AMS), with results given in units of “fraction of modern carbon” (f_{M}). f_{M} is defined by National Institute of Standards and Technology (NIST) Standard Reference Materials (SRMs) 4990B and 4990C, known as oxalic acids standards HOxI and HOxII, respectively. The fundamental definition relates to 0.95 times the ¹⁴C/¹²C isotope ratio HOxI (referenced to AD 1950). This is roughly equivalent to decay-corrected pre-Industrial Revolution wood. For the current living biosphere (plant material), f_{M}≈1.1.

The stable carbon isotope ratio (¹³C/¹²C) provides a complementary route to source discrimination and apportionment. The ¹³C/¹²C ratio in a given biosourced material is a consequence of the ¹³C/¹²C ratio in atmospheric carbon dioxide at the time the carbon dioxide is fixed and also reflects the precise metabolic pathway. Regional variations also occur. Petroleum, C₃ plants (the broadleaf), C₄ plants (the grasses), and marine carbonates all show significant differences in ¹³C/¹²C and the corresponding δ¹³C values. Furthermore, lipid matter of C₃ and C₄ plants analyze differently than materials derived from the carbohydrate components of the same plants as a consequence of the metabolic pathway. Within the precision of measurement, ¹³C shows large variations due to isotopic fractionation effects, the most significant of which for the instant invention is the photosynthetic mechanism. The major cause of differences in the carbon isotope ratio in plants is closely associated with differences in the pathway of photosynthetic carbon metabolism in the plants, particularly the reaction occurring during the primary carboxylation, i.e., the initial fixation of atmospheric CO₂. Two large classes of vegetation are those that incorporate the “C₃” (or Calvin-Benson) photosynthetic cycle and those that incorporate the “C₄” (or Hatch-Slack) photosynthetic cycle. C₃ plants, such as hardwoods and conifers, are dominant in the temperate climate zones. In C₃ plants, the primary CO₂ fixation or carboxylation reaction involves the enzyme ribulose-1,5-diphosphate carboxylase and the first stable product is a 3-carbon compound. C₄ plants, on the other hand, include such plants as tropical grasses, corn and sugar cane. In C₄ plants, an additional carboxylation reaction involving another enzyme, phosphenol-pyruvate carboxylase, is the primary carboxylation reaction. The first stable carbon compound is a 4-carbon acid, which is subsequently decarboxylated. The CO₂ thus released is refixed by the C₃ cycle.

Both C₄ and C₃ plants exhibit a range of ¹³C/¹²C isotopic ratios, but typical values are ca. −10 to −14 per mil (C₄) and −21 to −26 per mil (C₃) (Weber et al., J. Agric. Food Chem., 45, 2042 (1997)). Coal and petroleum fall generally in this latter range. The ¹³C measurement scale was originally defined by a zero set by pee dee belemnite (PDB) limestone, where values are given in parts per thousand deviations from this material. The “δ¹³C” values are in parts per thousand (per mil), abbreviated %, and are calculated as follows:

$${δ}^{13} C ≡ \frac{( {}^{13} C / {}^{12} C ) sample - ( {}^{13} C / {}^{12} C ) standard}{( {}^{13} C / {}^{12} C ) standard} \times 1000 {\%}_{o}$$

Since the PDB reference material (RM) has been exhausted, a series of alternative RMs have been developed in cooperation with the IAEA, USGS, NIST, and other selected international isotope laboratories. Notations for the per mil deviations from PDB is δ¹³C. Measurements are made on CO₂ by high precision stable ratio mass spectrometry (IRMS) on molecular ions of masses 44, 45 and 46.

Biologically-derived 1,3-propanediol, and compositions comprising biologically-derived 1,3-propanediol, therefore, may be completely distinguished from their petrochemical derived counterparts on the basis of ¹⁴C (f_{M}) and dual carbon-isotopic fingerprinting, indicating new compositions of matter. The ability to distinguish these products is beneficial in tracking these materials in commerce. For example, products comprising both “new” and “old” carbon isotope profiles may be distinguished from products made only of “old” materials. Hence, the instant materials may be followed in commerce on the basis of their unique profile and for the purposes of defining competition, for determining shelf life, and especially for assessing environmental impact.

Preferably the 1,3-propanediol used as a reactant or as a component of the reactant in making the polymers disclosed herein will have a purity of greater than about 99%, and more preferably greater than about 99.9%, by weight as determined by gas chromatographic analysis. Particularly preferred are the purified 1,3-propanediols as disclosed in U.S. Pat. No. 7,038,092, U.S. Pat. No. 7,098,368, U.S. Pat. No. 7,084,311 and US20050069997A1.

The purified 1,3-propanediol preferably has the following characteristics:

(1) an ultraviolet absorption at 220 nm of less than about 0.200, and at 250 nm of less than about 0.075, and at 275 nm of less than about 0.075; and/or

(2) a composition having a CIELAB “b*” color value of less than about 0.15 (ASTM D6290), and an absorbance at 270 nm of less than about 0.075; and/or

(3) a peroxide composition of less than about 10 ppm; and/or

(4) a concentration of total organic impurities (organic compounds other than 1,3-propanediol) of less than about 400 ppm, more preferably less than about 300 ppm, and still more preferably less than about 150 ppm, as measured by gas chromatography.

As disclosed in the embodiments herein, aliphatic-aromatic copolyetheresters can be generated without addition of a dialkylene glycol as a reactant to the polymerization vessel. Thermal properties of the polyesters made in the present embodiments can be attained via control over glycol ether formation as demonstrated by a shift in the melting temperature with a shift in dialkylene glycol content for copolyetheresters with similar dicarboxylic acid content. The added flexibility imparted by dimerization of the glycol can also be expected to alter other physical properties of the polymers. This control can be attained by monomer selection, catalyst selection, catalyst amount, choice of sulfonate group, addition of basic compounds, and other process conditions.

The aliphatic-aromatic copolyetheresters disclosed herein can optionally comprise a sulfonate component. In certain embodiments disclosed herein, the sulfonate component consists of sulfonate compounds including dimethyl 5-sulfoisophthalate sodium salt, toluenesulfonic acid, or mixtures thereof. These compounds can include compounds that incorporate into the backbone of the polymer chain and those that do not. As a class, these compounds generally consist of those with strong acid moieties. Such compounds promote the dimerization of glycols during the reaction and thus act as dimerization catalysts. Generally, these compounds are used in amounts of between about 0 and 5 mole percent based on the total moles of diacid component and glycol component incorporated into the aliphatic-aromatic copolyetherester formed. Typically, the sulfonate component is used in an amount between 0.1 and 1 mole percent. In some embodiments, the sulfonate component is used in an amount greater than 1 mole percent.

Other compounds are added during the process to make the aliphatic-aromatic copolyetheresters disclosed herein. These compounds include tetramethylammonium hydroxide, a basic compound, which is added to limit the formation of glycol ether. Generally, as a class, these compounds consist of those with basic moieties. Such compounds limit the dimerization of glycols during the reaction. Generally these compounds are added at 1 to 1000 ppm level based on the total weight of the aliphatic-aromatic copolyetherester.

Catalysts are generally used in the processes disclosed herein. A number of ester interchange catalysts can be used, including but not limited to titanium alkoxides, including titanium (IV) isoproproxide. The amounts of catalysts added can favor or disfavor the production of glycol ethers. More specifically, by adjusting the level of the ester interchange catalyst described here relative to the dimerization catalyst described above, one can control the relative rates of the two reactions and thus the ultimate degree of dimerization that occurs. A number of other process parameters can be used to control the degree of dimerization achieved during reaction. For example, reacting dimethyl esters of carboxylic acids rather than dicarboxylic acids with the diol monomer reduces glycol formation. As another example, the mole percent of glycol dimer incorporated into the final polymer is increased when larger excesses of the diol monomer are charged to the reaction vessel.

Processes to make the aliphatic-aromatic copolyetheresters are also disclosed herein. Such processes can be operated in either a batch, semi-batch, or in a continuous mode using suitable reactor configurations. The reactor used to prepare the polymers disclosed in the embodiments herein is equipped with a means for heating the reaction to 260° C. or higher, a fractionation column for distilling off volatile liquids, an efficient stirrer capable of stirring a high viscosity melt, a means for blanketing the reactor contents with nitrogen, and a vacuum system capable of achieving a vacuum of less than 1 Torr.

This process was generally carried out in two steps. In the first step, dicarboxylic acid monomers or their diester derivatives were reacted with a diol in the presence of an ester interchange catalyst, which caused exchange of the diol for the alcohol group of the ester and/or the hydroxyl group of the acid. This resulted in the formation of alcohol and/or water, which distilled out of the reaction vessel, and diol adducts of the dicarboxylic acids. The exact amount of monomers charged to the reactor was readily determined by a skilled practitioner depending on the amount of polymer desired and its composition. It was advantageous to use excess diol in the ester interchange step, specifically more than is required to provide equimolar proportions of hydroxyl moieties and carboxylic acid moieties or ester-forming derivatives thereof to the reaction vessel, with the excess distilled off during the second, polycondensation step. A diol excess of 10 to 100% was commonly used. Ester interchange catalysts are generally known in the art, and preferred catalysts for this process were titanium alkoxides. The amount of catalyst used was usually 20 to 200 parts titanium per million parts polymer. The combined monomers are heated gradually with mixing to a temperature in the range of 200 to 250° C. Depending on the reactor and the monomers used, the reactor may be heated directly to 250° C., or there may be a hold at a temperature in the range of 200 to 220° C. to allow the ester interchange to occur and the volatile products to distill out without loss of the excess diol. The ester interchange step was usually completed at a temperature ranging from 240 to 260° C. The completion of the interchange step was determined from the amount of alcohol and/or water collected and by falling temperatures at the top of the distillation column.

The second step, polycondensation, was carried out at 240 to 260° C. under vacuum to distill out the excess diol. It was preferred to apply the vacuum gradually to avoid bumping of the reactor contents. Stirring was continued under full vacuum (generally less than 1 Torr) until the desired melt viscosity was reached. A practitioner experienced with the reactor would be able to determine if the reaction had reached the desired melt viscosity from the torque on the stirrer motor. Generally, desirable physical properties are achieved when zero shear melt viscosity at 260° C. is greater than at least 1000 Poise. More typically, values above 2000 Poise are achieved. In some embodiments, values above 5000 Poise are desired.

The aliphatic-aromatic copolyetheresters can be blended with other polymeric materials. Such materials can be biodegradable or not biodegradable. The materials can be naturally derived, modified naturally derived or synthetic. According to DIN EN13432, a material is considered biodegradable if greater than 90% of its organic carbon is converted to carbon dioxide prior to 180 days in a controlled aerobic composting test. Examples of biodegradable materials suitable for blending with the aliphatic-aromatic copolyetheresters include poly(hydroxy alkanoates), polycarbonates, poly(caprolactone), aliphatic polyesters, aliphatic-aromatic copolyesters, aliphatic-aromatic copolyetheresters, aliphatic-aromatic copolyamideesters, sulfonated aliphatic-aromatic copolyesters, sulfonated aliphatic-aromatic copolyetheresters, sulfonated aliphatic-aromatic copolyamideesters, and copolymers and mixtures derived therefrom. Specific examples of blendable biodegradable materials include the Biomax® sulfonated aliphatic-aromatic copolyesters of the DuPont Company, the Eastar Bio® aliphatic-aromatic copolyesters of the Eastman Chemical Company, the Ecoflex® aliphatic-aromatic copolyesters of the BASF corporation, poly(1,4-butylene terephthalate-co-adipate, (50:50, molar), the EnPol® polyesters of the Ire Chemical Company, poly(1,4-butylene succinate), the Bionolle® polyesters of the Showa High Polymer Company, poly(ethylene succinate), poly(1,4-butylene adipate-co-succinate), poly(1,4-butylene adipate), poly(amide esters), the Bak® poly(amide esters) of the Bayer Company, poly(ethylene carbonate), poly(hydroxybutyrate), poly(hydroxyvalerate), poly(hydroxybutyrate-co-hydroxyvalerate), the Biopol® poly(hydroxy alkanoates) of the Monsanto Company, poly(lactide-co-glycolide-co-caprolactone), the Tone® poly(caprolactone) of the Union Carbide Company, the EcoPLA® poly(lactide) of the Cargill Dow Company and mixtures derived therefrom. Essentially any biodegradable material can be blended with the aliphatic-aromatic copolyetheresters. Clearly, any necessary compatibilizers and process conditions will depend on the selected blend material.

Examples of nonbiodegradable polymeric materials suitable for blending with the aliphatic-aromatic copolyetheresters include polyethylene, high density polyethylene, low density polyethylene, linear low density polyethylene, ultralow density polyethylene, polyolefins, ply(ethylene-co-glycidylmethacrylate), poly(ethylene-co-methyl(meth)acrylate-co-glycidyl acrylate), poly(ethylene-co-n-butyl acrylate-co-glycidyl acrylate), poly(ethylene-co-methyl acrylate), poly(ethylene-co-ethyl acrylate), poly(ethylene-co-butyl acrylate), poly(ethylene-co-(meth)acrylic acid), metal salts of poly(ethylene-co-(meth)acrylic acid), poly((meth)acrylates), such as poly(methyl methacrylate), poly(ethyl methacrylate), poly(ethylene-co-carbon monoxide), poly(vinyl acetate), poly(ethylene-co-vinyl acetate), poly(vinyl alcohol), poly(ethylene-co-vinyl alcohol), polypropylene, polybutylene, polyesters, poly(ethylene terephthalate), poly(1,3-propyl terephthalate), poly(1,4-butylene terephthalate), PETG, poly(ethylene-co-1,4-cyclohexanedimethanol terephthalate), poly(vinyl chloride), PVDC, poly(vinylidene chloride), polystyrene, syndiotactic polystyrene, poly(4hydroxystyrene), novalacs, poly(cresols), polyamides, nylon, nylon 6, nylon 46, nylon 66, nylon 612, polycarbonates, poly(bisphenol A carbonate), polysulfides, poly(phenylene sulfide), polyethers, poly(2,6-dimethylphenylene oxide), polysulfones, and copolymers thereof and mixtures derived therefrom.

Examples of natural polymeric materials suitable for blending with the aliphatic-aromatic copolyetheresters include starches such as starch, starch derivatives, modified starch, thermoplastic starch, cationic starch, anionic starch, starch esters, such as starch acetate, starch hydroxyethyl ether, alkyl starches, dextrins, amine starches, phosphate starches, dialdehyde starches; celluloses such as cellulose, cellulose derivatives, modified cellulose, cellulose esters, such as cellulose acetate, cellulose diacetate, cellulose propionate, cellulose butyrate, cellulose valerate, cellulose triacetate, cellulose tripropionate, cellulose tributyrate, and cellulose mixed esters, such as cellulose acetate propionate and cellulose acetate butyrate, cellulose ethers, such as methylhydroxyethylcellulose, hydroxymethylethylcellulose, carboxymethylcellulose, methyl cellulose, ethylcellulose, hydroxyethylcellulose, and hydroxyethylpropylcellulose; polysaccharides, alginic acid, alginates, phycocolloids, agar, gum arabic, guar gum, acacia gum, carrageenan gum, furcellaran gum, ghatti gum, psyllium gum, quince gum, tamarind gum, locust bean gum, gum karaya, xanthan gum, gum tragacanth, proteins, prolamine, collagen and derivatives thereof such as gelatin and glue, casein, sunflower protein, egg protein, soybean protein, vegetable gelatins, gluten, and mixtures derived therefrom. Thermoplastic starch can be produced, for example, as disclosed within U.S. Pat. No. 5,362,777. Essentially any natural polymeric material known can be blended with the aliphatic-aromatic copolyetheresters.

The aliphatic-aromatic copolyetheresters can be used to make a wide variety of shaped articles. Shaped articles that can be made from the aliphatic-aromatic copolyetheresters include film, sheets, fiber, melt blown containers, molded parts such as cutlery, foamed parts, coatings, polymeric melt extrusion coatings on substrates, polymeric solution coatings onto substrates, and laminates. The aliphatic-aromatic copolyetheresters are useful in making any shaped article that can be made from a polymer such as a copolyester. The aliphatic-aromatic copolyetheresters can be formed into such shaped articles using any known process therefore.

### EXAMPLES

### Test Methods

The intrinsic viscosity (IV) of polyester polymer was determined using a Viscotek Forced Flow Viscometer (FFV) Model Y-900. Samples were dissolved in 50/50 wt % trifluoroacetic acid/methylene chloride (TFA/CH₂Cl₂) at a 0.4% (wt/vol) concentration at 19° C. The intrinsic viscosity values reported by this method were equivalent to values determined using Goodyear Method R-103b “Determination of Intrinsic Viscosity in 50/50 [by weight] Trifluoroacetic Acid/Dichloromethane”.

This method can be applied to any polyester (i.e. poly(ethylene terephthalate (PET), poly(trimethylene terephthalate (3GT), poly(butylene terephthalate (PBT), poly(ethylene naphthalate (PEN)) which is completely soluble in the 50/50 wt % TFA/CH₂Cl₂ solvent mixture.

A sample size of 0.1000 g polyester was typically used to prepare a 25 ml polymer solution. Complete dissolution of the polymer generally occurred within 8 hours at room temperature. Dissolution time was dependent on the molecular weight, crystallinity, chemical structure, and form (i.e. fiber, film, ground, pellet) of the polyester.

The compositions of the polymers were determined by Nuclear Magnetic Resonance spectroscopy, NMR. Several pellets or flakes for each sample were dissolved in trifluoroacetic acid-d1 at room temp (one can also heat the sample to 50° C. without seeing any structural changes in order to speed up dissolution). The samples were placed in a 10 mm NMR tube and enough solvent was added to totally dissolve the sample. They were then placed in a 5 mm NMR tubes and their NMR spectra were obtained at 30° C. on a Varian S 400 MHz Spectrometer. Mole-% composition of the sample was determined from integration of appropriate areas of the spectrum. The mole percents indicated for the di-n-propylene glycol (DPG) contents of the examples are on the basis of all monomers (both the acid component and the glycol component) that make up the polymer. Since the copolyetheresters consist of equal parts acid component and glycol component, these values would be doubled if it is desired to convert to a basis of the glycol component alone.

Differential Scanning calorimetry, DSC, was performed on a TA Instruments (New Castle, Del.) Model Number 2920 under a nitrogen atmosphere. Samples were heated from 20° C. to 270° C. at 20° C./min., held at 270° C. for 5 min., quenched in liquid N2, heated from −100° C. to 270° C. at 10° C./min. (Tg), held at 270° C. for 3 min., cooled to −100° C. at 10° C./min. (Tc), held at −100° C. for 2 minutes, and heated from −100° to 270° C. at 10 C/min. (Tc and Tm).

1,3-Propanediol was obtained from DuPont/Tate & Lyle, Loudon, Tenn., USA.

All other chemicals, reagents and materials were obtained from Aldrich Chemical Company, Milwaukee, Wis., USA.

### Examples 1-4

Examples 1-4 demonstrate that glycol ether formation can be controlled by varying the process conditions used to produce otherwise very similar compositions. These examples demonstrate that the presence of a compound with a strong acid moiety, for example a sulfonated compound, promotes dimerization of diol monomers. They also demonstrate that the use of methyl esters of dicarboxylic acids rather than the dicarboxylic acids themselves during polymerization can limit the formation of glycol dimers.

### Example 1

To a 250 mL glass flask were added 35.7 g 1,3-propanediol, 42.0 g dimethyl terephthalate, 27.7 g sebacic acid, 2.1 g dimethyl 5-sulfoisophthalate sodium salt, and 0.024 g titanium(IV) isopropoxide. The reaction mixture was stirred while the vessel was evacuated by vacuum to approximately 100 Torr and brought back to atmospheric pressure under nitrogen 3 times. With continuous stirring under the nitrogen atmosphere, the reaction mixture was first heated to 160° C. over 10 minutes and then to 210° C. over an additional 40 minutes. The reaction mixture was held at this temperature under the nitrogen atmosphere with continuous stirring for 35 minutes. The reaction mixture was then heated to 250° C. over 45 minutes and held at this temperature for 30 minutes while 26 mL of distillate was collected. The reaction vessel was then staged to full vacuum (approximately 60 mTorr) over the course of 30 minutes with continuous stirring at 250° C. The vessel was held under these conditions for a further 3 hours while additional distillate was collected. Vacuum was then released with nitrogen, and the reaction mixture was allowed to return to room temperature. Under laboratory analysis, the sample was determined to have an IV of 1.3 dL/g, a Tm of 155° C., and a DPG content of 0.9 mole %.

### Example 2

To a 250 mL glass flask were added 36.0 g 1,3-propanediol, 37.5 g terephthalic acid, 28.0 g sebacic acid, and 0.024 g titanium(IV) isopropoxide. The reaction mixture was stirred while the vessel was evacuated by vacuum to approximately 100 Torr and brought back to atmospheric pressure under nitrogen 3 times. With continuous stirring under the nitrogen atmosphere, the reaction mixture was first heated to 160° C. over 10 minutes and then to 250° C. over an additional 40 minutes. The reaction mixture was held at this temperature under the nitrogen atmosphere with continuous stirring for 2 hours while 12 mL of distillate was collected. The reaction vessel was then staged to full vacuum (approximately 60 mTorr) over the course of 1 hour with continuous stirring at 250° C. The vessel was held under these conditions for a further 2 hours while additional distillate was collected. Vacuum was then released with nitrogen, and the reaction mixture was allowed to return to room temperature. Under laboratory analysis, the sample was determined to have an IV of 1.7 dL/g, a Tm of 155° C., and a DPG content of 0.2 mole %.

### Example 3

To a 250 mL glass flask were added 36.0 g 1,3-propanediol, 43.8 g dimethyl terephthalate, 28.0 g sebacic acid, and 0.024 g titanium(IV) isopropoxide. The reaction mixture was stirred while the vessel was evacuated by vacuum to approximately 100 Torr and brought back to atmospheric pressure under nitrogen 3 times. With continuous stirring under the nitrogen atmosphere, the reaction mixture was first heated to 160° C. over 10 minutes and then to 210° C. over an additional 50 minutes. The reaction mixture was held at this temperature under the nitrogen atmosphere with continuous stirring for 20 minutes. The reaction mixture was then heated to 250° C. over 50 minutes and held at this temperature for 2 hours while 16 mL of distillate was collected. The reaction vessel was then staged to full vacuum (approximately 60 mTorr) over the course of 25 minutes with continuous stirring at 250° C. The vessel was held under these conditions for a further 3 hours while additional distillate was collected. Vacuum was then released with nitrogen, and the reaction mixture was allowed to return to room temperature. Under laboratory analysis, the sample was determined to have an IV of 0.9 dL/g, a Tm of 157° C., and a DPG content of 0.1 mole %.

### Example 4

To a 250 mL glass flask were added 35.7 g 1,3-propanediol, 35.9 g terephthalic acid, 27.7 g sebacic acid, 2.1 g dimethyl 5-sulfoisophthalate sodium salt, and 0.024 g titanium(IV) isopropoxide. The reaction mixture was stirred while the vessel was evacuated by vacuum to approximately 100 Torr and brought back to atmospheric pressure under nitrogen 3 times. With continuous stirring under the nitrogen atmosphere, the reaction mixture was first heated to 160° C. over 10 minutes and then to 250° C. over an additional 30 minutes. The reaction mixture was held at this temperature under the nitrogen atmosphere with continuous stirring for 2.5 hours while 13 mL of distillate was collected. The reaction vessel was then staged to full vacuum (approximately 60 mTorr) over the course of 10 minutes with continuous stirring at 250° C. The vessel was held under these conditions for a further 3.5 hours while additional distillate was collected. Vacuum was then released with nitrogen, and the reaction mixture was allowed to return to room temperature. Under laboratory analysis, the sample was determined to have an IV of 1.1 dL/g, a Tm of 127° C., and a DPG content of 7.9 mole %.

### Examples 5-20

These examples illustrate that control over thermal properties of polyesters can be attained via control over glycol ether formation. They also illustrate that in addition to the choice of monomers (as illustrated in examples 1-4), outside factors can be used to control glycol ether formation. As one example, a sulfonated compound, toluenesulfonic acid, that does not incorporate into the polymer chain, can be used in place of one that does, dimethyl 5-sulfoisophthalate sodium salt. As another, a basic compound, tetramethylammonium hydroxide, can be used to limit formation of the glycol ether. The level of catalyst used to promote esterification can be used to favor or disfavor production of glycol ethers. Generally, the amount of the above compounds added to the reaction vessel can be adjusted to control dimerization of the charged glycols.

These syntheses were carried out with minor variation to the listed times as follows. To a 250 mL glass flask were added the mass of monomers listed in the table below. The reaction mixture was stirred while the vessel was evacuated by vacuum to approximately 100 Torr and brought back to atmospheric pressure under nitrogen 3 times. With continuous stirring under the nitrogen atmosphere, the reaction mixture was first heated to 160° C. over 10 minutes and then to 210° C. over an additional 50 minutes. The reaction mixture was held at this temperature under the nitrogen atmosphere with continuous stirring for 30 minutes. The reaction mixture was then heated to 250° C. over 30 minutes and held at this temperature for 1.5 hours while distillate was collected. The reaction vessel was then staged to full vacuum (approximately 60 mTorr) over the course of 30 minutes with continuous stirring at 250° C. The vessel was held under these conditions for a further 3 hours while additional distillate was collected. Vacuum was then released with nitrogen, and the reaction mixture was allowed to return to room temperature. Under laboratory analysis, the sample was determined to have the properties listed in the table below.

For reference, the compounds have been abbreviated as follows: 1,3-propanediol (3G), dimethyl terephthalate (DMT), terephthalic acid (TPA), sebacic acid (Seb), dimethyl 5-sulfoisophthalate sodium salt (SIPA), titanium(IV) isopropoxide (TPT), toluenesulfonic acid (TsOH), tetramethylammonium hydroxide, microliters of a 3M aqueous solution (TMAH), di-n-propylene glycol (DPG).

TABLE 1

| | | | | | | | | TMAH | | | DPG |
|---|---|---|---|---|---|---|---|---|---|---|---|
| | 3G | DMT | TPA | Seb | SIPA | TPT | TsOH | (uL 3M | IV | Tm | (mole |
| Example | (g) | (g) | (g) | (g) | (g) | (g) | (g) | sol) | (dL/g) | (° C.) | %) |
| 5 | 37.1 | | 49.8 | 15.2 | | 0.01 | 0.14 | 293 | 1.3 | 183 | 5.2 |
| 6 | 57 | | 49.7 | 15.2 | 0.22 | 0.1 | | | 1.5 | 188 | 2.6 |
| 7 | 35.5 | | 34.6 | 29.1 | 2.1 | 0.01 | | | 1.3 | 117 | 7.7 |
| 8 | 55.2 | 42.2 | | 29.3 | | 0.01 | 0.14 | | 1.4 | 115 | 8.2 |
| 9 | 35.8 | 42.1 | | 29.3 | 0.21 | 0.1 | | 293 | 1.1 | 154 | 0.1 |
| 10 | 55.2 | | 36.1 | 29.3 | | 0.1 | 1.4 | 293 | 0.6 | 90 | 35.2 |
| 11 | 56.5 | 56.2 | | 15 | 2.2 | 0.01 | | 293 | 1.0 | 192 | 0.5 |
| 12 | 37.1 | 58.2 | | 15.2 | | 0.1 | 1.4 | | 1.1 | 188 | 4.1 |
| 13 | 57 | 58.23 | | 15.2 | | 0.1 | 0.14 | 293 | 0.6 | 197 | 1.7 |
| 14 | 55.1 | | 36 | 29.3 | 0.21 | 0.01 | | 293 | 0.9 | 153 | 0.8 |
| 15 | 37 | 58 | | 15.2 | 0.22 | 0.01 | | | 0.9 | 199 | 0.5 |
| 16 | 35.9 | | 36.1 | 29.3 | | 0.1 | 0.14 | | 0.8 | 105 | 13.1 |
| 17 | 54.7 | 40.5 | | 29.1 | 2.1 | 0.1 | | | 0.8 | 144 | 2.1 |
| 18 | 57 | | 49.8 | 15.2 | | 0.01 | 1.4 | | 0.5 | 94 | 43.6 |
| 19 | 35.9 | 42.2 | | 29.3 | | 0.01 | 1.4 | 293 | 0.1 | | 19.7 |
| 20 | 36.7 | | 48.1 | 15 | 2.2 | 0.1 | | 293 | 0.8 | 187 | 2.0 |

### Example 21

This example illustrates that other diols can be used in the process described above to incorporate di(alkylene ether)glycols into aliphatic-aromatic copolyetheresters.

To a 250 mL glass flask were added 31.0 g 1,2-ethanediol, 37.0 g terephthalic acid, 31.1 g sebacic acid, 2.3 g dimethyl 5-sulfoisophthalate sodium salt, and 0.024 g titanium(IV) isopropoxide. The reaction mixture was stirred while the vessel was evacuated by vacuum to approximately 100 Torr and brought back to atmospheric pressure under nitrogen 3 times. With continuous stirring under the nitrogen atmosphere, the reaction mixture was first heated to 160° C. over 10 minutes and then to 210° C. over an additional 40 minutes. The reaction mixture was held at this temperature under the nitrogen atmosphere with continuous stirring for 30 minutes. The reaction mixture was then heated to 250° C. over 25 minutes and held at this temperature for 105 minutes while 14 mL of distillate was collected. The reaction vessel was then staged to full vacuum (approximately 60 mTorr) over the course of 25 minutes with continuous stirring at 250° C. The vessel was held under these conditions for a further 140 minutes while additional distillate was collected. Vacuum was then released with nitrogen, and the reaction mixture was allowed to return to room temperature. Under laboratory analysis, the sample was determined to have an IV of 0.92 dL/g, a Tg of −3° C., and a diethylene glycol content of 5.9 mole %.

What is claimed is:

1. An aliphatic-aromatic copolyetherester comprising an acid component and a glycol component; wherein the acid component comprises:
a. about 90 to 10 mole percent of an aromatic dicarboxylic acid component based on 100 mole percent total acid component; and
b. about 10 to 90 mole percent of an aliphatic dicarboxylic acid component based on 100 mole percent of total acid component; and
wherein the glycol component consists essentially of:
a. about 99.8 to 0.2 mole percent of a single glycol component based on 100 mole percent total glycol component; and
b. about 0.2 to 99.8 mole percent of a dialkylene glycol component based on 100 mole percent total glycol component.

2. The aliphatic-aromatic copolyetherester of claim 1 obtainable by reacting an acid component mixture comprising:
a. about 90 to 10 mole percent of an aromatic dicarboxylic acid or ester-forming derivative thereof based on 100 mole percent total acid component, and
b. about 10 to 90 mole percent of an aliphatic dicarboxylic acid or ester-forming derivative thereof based on 100 mole percent of total acid component,
and a glycol component consisting essentially of:
c. 100 mole percent of a single glycol component based on 100 mole percent total glycol component.

3. The aliphatic-aromatic copolyetherester of claim 1 wherein the single glycol component is chosen from 1,2-ethanediol, 1,3-propanediol, and 1,4-butanediol.

4. The aliphatic-aromatic copolyetherester of claim 1, further comprising between 0 and about 5 mole percent of a sulfonate component.

5. The aliphatic-aromatic copolyetherester of claim 4, wherein the sulfonate component is dimethyl 5-sulfoisophthalate sodium salt, toluenesulfonic acid, or mixtures thereof.

6. A blend comprising the aliphatic-aromatic copolyetherester of claim 1 and at least one other polymer.

7. The blend of claim 6 wherein the other polymer is a natural polymer.

8. The blend of claim 7 wherein the natural polymer is a starch.

9. A shaped article formed from the aliphatic-aromatic copolyetherester of claim 1.

10. A shaped article of claim 9 selected from the group consisting of films, sheets, fibers, melt blown containers, molded parts, and foamed parts.

11. A process for making an aliphatic-aromatic copolyetherester, comprising:
a. combining one or more dicarboxylic acid monomers or diester derivatives thereof with a diol in the presence of an ester interchange catalyst to form a first reaction mixture of an ester interchange reaction;
b. heating the first reaction mixture with mixing to a temperature between about 200 degrees C. and about 260 degrees C., whereby volatile products of the ester interchange reaction are distilled off, to form a second reaction mixture; and
c. polycondensing the second reaction mixture with stirring at a temperature between about 240 degrees C. and 260 degrees C. under vacuum to form the aliphatic-aromatic copolyetherester.

12. The process of claim 11, wherein the diol consists essentially of 100 mole percent of a single glycol component based on 100 mole percent total glycol component.

13. The process of claim 11 or 12, wherein the diol is added in an s excess of between about 10% and 100% relative to that needed to provide equimolar proportions of hydroxyl moieties and carboxylic acid moieties or ester-forming derivatives thereof to the reaction vessel.

14. The process of claim 11 or 12, wherein the ester interchange catalyst is a titanium alkoxide used in an amount of about 20 to 200 parts titanium per million parts polymer.

15. The process of claim 11 or 12, wherein the polycondensation is continued until a desired melt viscosity of the aliphatic-aromatic copolyetherester is achieved.

16. The aliphatic-aromatic copolyetherester of claim 1 wherein the aliphatic dicarboxylic acid component is selected from the group consisting of succinic acid, azelaic acid, sebacic acid, and brassylic acid.

17. The aliphatic-aromatic copolyetherester of claim 1 wherein the aromatic dicarboxylic acid component is selected from the group consisting of terephthalic acid and dimethyl terephthalate.

18. The aliphatic-aromatic copolyetherester of claim 1 wherein the copolyetherester is semicrystalline.
